(19) United States
(12) Patent Application Publication
(10) Pub. No.: US 2008/0202622 A1
(43) Pub. Date: Aug. 28, 2008

(54) REFRIGERANT PIPE FOR REFRIGERATION CYCLE AND MANUFACTURING METHOD OF THE SAME

(76) Inventors: Hae-Soo CHO, Gwangsan-gu (KR); Jin-Hwan BAE, Gwangsan-gu (KR)

Correspondence Address: BLANK ROME LLP, 600 NEW HAMPSHIRE AVENUE, N.W., WASHINGTON, DC, 20037, US

(21) Appl. No.: 12/035,184

(22) Filed: Feb. 21, 2008

(30) Foreign Application Priority Data
Feb. 27, 2007 (KR) 10-2007-19721

(51) Int. Cl. F16L 9/22; B23P 17/00; F16L 13/00

(52) U.S. Cl. 138/155; 29/421.1; 138/109; 285/285.1

(57) ABSTRACT

A refrigerant pipe for a refrigeration cycle and manufacturing method of the same. The refrigeration cycle has components including a compressor, a condenser, an evaporator and an expander that are connected to each other via the plurality of refrigerant pipes such that the refrigeration cycle forms a closed loop. Each refrigerant pipe includes a main pipe section having a first and a second end, and a connection pipe section at the first end and the second end of the main pipe section configured to be connected to the components of the refrigeration cycle, wherein a thickness of the connection pipe section is larger than a thickness of the main pipe section.

### CROSS-REFERENCE TO RELATED APPLICATION

This application claims the benefit under 35 U.S.C. §119(a) of Korean Patent Application No. 10-2007-0019721, filed Feb. 27, 2007, in the Korean Intellectual Property Office, the entire disclosure of which is incorporated herein by reference.

### FIELD OF THE INVENTION

The present invention relates to a refrigerant pipe used for a refrigeration cycle and a manufacturing method of the same. More particularly, the present invention relates to a refrigerant pipe that is employed in a refrigeration cycle to connect components of the refrigeration cycle to each other, and a manufacturing method of the same.

### BACKGROUND OF THE INVENTION

In general, a refrigeration cycle is adopted in a refrigerator or an air conditioner to perform a cooling operation. Such a refrigeration cycle includes components, such as a compressor, a condenser, an evaporator and an expander. These components are connected to each other via refrigerant pipes so that the refrigeration cycle is performed in the form of a closed loop.

The conventional refrigerant pipe has constant inner and outer diameters over the whole area thereof. Each component of the refrigeration cycle is formed with a coupling section having a substantially pipe shape such that the component can be coupled with the refrigerant pipe. Both ends of the refrigerant pipe are welded to the coupling section of the each component.

The ends of the conventional refrigerant pipe, which are welded to the coupling section of the component, are thermally deformed due to the heat generated during the welding process so that the strength of the refrigerant pipe may be lowered at the ends of the refrigerant pipe. If the ends of the refrigerant pipe have low strength, the ends of the refrigerant pipe coupled with the coupling section of the component may be broken as vibration is applied to the refrigerant pipe during the refrigeration cycle.

In response to this problem, there is a tendency to increase the thickness of the refrigerant pipe to reinforce the strength at the ends of the refrigerant pipe. Although the strength can be reinforced at the ends of the refrigerant pipe coupled with the component by increasing the thickness of the refrigerant pipe, a greater amount of material is, therefore, necessary to manufacture the refrigerant pipe.

### SUMMARY OF THE INVENTION

Accordingly, to solve at least the above problems and/or disadvantages and to provide at least the advantages described below, a non-limiting object of the present invention is to provide a refrigerant pipe, and a manufacturing method of the same, in which strength each refrigerant pipe includes a main pipe section having a first and a second end, and a connection pipe section at the first end and the second end of the main pipe section configured to be connected to the components of the refrigeration cycle, wherein a thickness of the connection pipe section is larger than a thickness of the main pipe section.

It is another aspect of the present invention to provide a method of manufacturing a refrigerant pipe for a refrigeration cycle having components including a compressor, a condenser, an evaporator and an expander that are connected to each other via the refrigerant pipe such that the refrigeration cycle forms a closed loop. The method includes forming connection pipe sections at a first end and a second end of the refrigerant pipe such that the connection pipe sections have a thickness larger than a thickness of a main pipe section formed between the connection pipe sections, wherein the refrigerant pipe is obtained by forming a linear primary pipe having a constant thickness through a drawing process, and then forming the connection pipe sections by deforming both ends of the linear primary pipe while applying pressure lengthwise along the linear primary pipe.

### BRIEF DESCRIPTION OF THE DRAWINGS

The above and other aspects of the present invention will be more apparent from the following detailed description of exemplary embodiments with reference to the accompanying drawings, in which:

FIG. 1 is a schematic view showing a structure of a refrigeration cycle according to a non-limiting exemplary embodiment of the present invention;

FIG. 2 is an elevational view of a compressor showing an enlarged sectional view of a connection structure between a refrigerant pipe for a refrigerant cycle and the compressor according to a non-limiting exemplary embodiment of the present invention;

FIG. 3 is a sectional view showing the structure of a refrigerant pipe for a refrigerant cycle according to a non-limiting exemplary embodiment of the present invention;

FIG. 4 is a sectional view showing the structure of a primary pipe used to manufacture a refrigerant pipe for a refrigeration cycle according to a non-limiting exemplary embodiment of the present invention;

FIGS. 5 and 6 are sectional views sequentially showing the manufacturing process for a refrigerant pipe according to a non-limiting exemplary embodiment of the present invention; and

FIGS. 7 and 8 are sectional views showing a structure of a refrigerant pipe for a refrigerant cycle according to another non-limiting embodiment of the present invention.

### DETAILED DESCRIPTION OF EXEMPLARY EMBODIMENTS

Reference will now be made in detail to non-limiting embodiments of the present invention by way of reference to the accompanying drawings, wherein like reference numerals refer to like parts, components and structures.

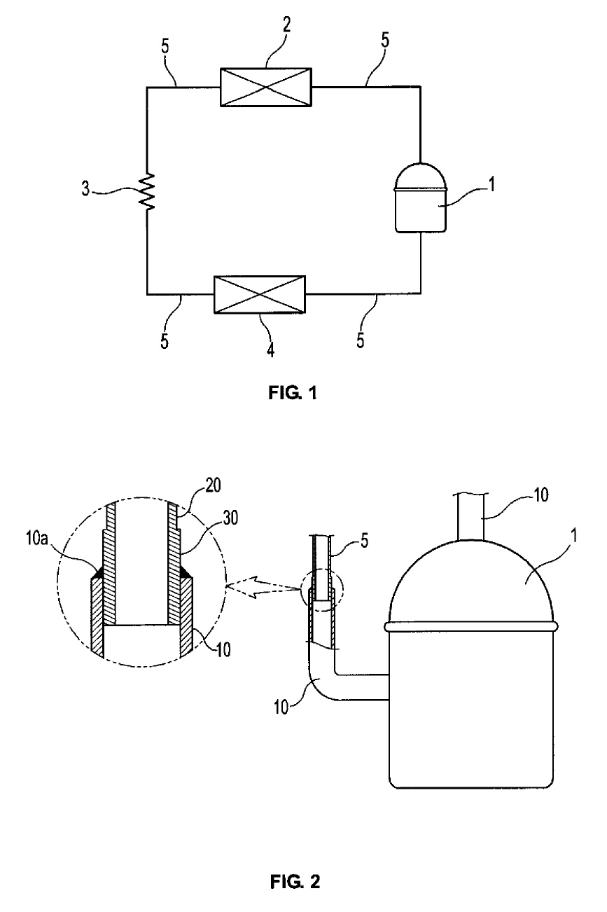

FIG. 1 is a schematic view showing the structure of a refrigeration cycle according to an exemplary embodiment of the present invention. As shown in FIG. 1, the refrigeration cycle of the present invention may employed in a refrigerator, an air conditioner, or a water purifier to perform a cooling operation. The refrigeration cycle includes components, such as a compressor 1, a condenser 2, an evaporator 3 and an expander 4. In addition, a plurality of refrigerant pipes 5 are connected between the components 1, 2, 3 and 4 such that the refrigeration cycle forms a closed loop.

In the refrigeration cycle of FIG. 1, the compressor 1 compresses a refrigerant into a gas-phase refrigerant having high temperature and pressure and the condenser 2 condenses the gas-phase refrigerant, which is delivered from the compressor 1, into a liquid-phase refrigerant having high temperature and pressure. The liquid-phase refrigerant, which has been condensed in the condenser 2, is subject to throttling expansion while passing through the expander 3 so that a liquid-phase refrigerant having low temperature and pressure is obtained. The evaporator 4 evaporates the liquid-phase refrigerant having low temperature and pressure to generate a gas-phase refrigerant having low temperature and pressure. In this non-limiting embodiment, the expander 3 may include a capillary tube as shown in the FIG. 1 or an expansion valve.

The refrigerant that circulates through the refrigerant cycle emits heat while being condensed in the condenser 2 and absorbs ambient heat while being evaporated in the evaporator 4. The refrigerator or the air conditioner performs the cooling operation by using the heat absorption function of the evaporator 4.

FIG. 2 is an elevational view of a compressor I showing an enlarged sectional view of a connection structure between a refrigerant pipe 5 for a refrigerant cycle and the compressor 1 according to an exemplary embodiment of the present invention. The connection structure between the refrigerant pipe 5 and other components, such as the condenser 2, the expander 3 and the evaporator 4, is identical to the connection structure between the refrigerant pipe 5 and the compressor 1, so detailed descriptions thereof are omitted below.

As shown in FIG. 2, each of the components 1, 2, 3 and 4 has a pair of coupling sections 10 with a short pipe shape so as to be coupled with a refrigerant pipe 5, respectively. In the case of the compressor 1, one of the coupling sections 10 is coupled with an end of a refrigerant pipe 5 opposite to an end connected to the evaporator 4 so that the refrigerant that has passed through the evaporator 5 may be introduced into the compressor 1 via the refrigerant pipe 5. In addition, the other coupling section 10 of the compressor 1 is coupled with an end of a refrigerant pipe 5 opposite to an end connected to the condenser 2 so that the refrigerant that has been compressed in the compressor 1 can be delivered to the condenser 2 via the refrigerant pipe 5.

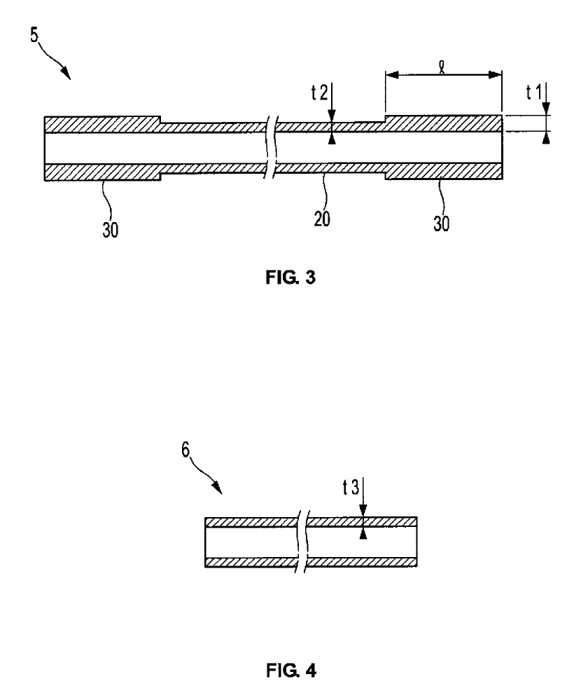

As shown in FIGS. 2 and 3, the plurality of refrigerant pipes 5 for the refrigeration cycle according to the present embodiment may each include a main pipe section 20 provided at the center of the refrigerant pipe 5 and a pair of connection pipe sections 30 provided at both sides of the main pipe section 30 so the refrigerant pipe may be coupled with the coupling sections 10 of the components 1, 2, 3 and 4. The main pipe section 20 has an inner diameter identical to that of the connection pipe section 30. However, the outer diameter of the connection pipe section 30 is larger than the outer diameter of the main pipe section 20 so that the thickness “t1” of the connection pipe section 30 is thicker than the thickness “t2” of the main pipe section 20.

Since the thickness “t1” of the connection pipe section 30 is larger relative to the thickness “t2” of the main pipe section 20, the strength of the refrigerant pipe 5 is reinforced at the connection pipe sections 30 when coupled with the components 1, 2, 3 and 4 of the refrigeration cycle. Accordingly, the coupling strength between the coupling sections 10 of the components 1, 2, 3 and 4 and the refrigerant pipe 4 is improved.

As illustrated in FIG. 2, one end of the connection pipe section 30 may be inserted into the coupling section 10, and then the connection pipe section 20 may be fixed to the coupling section 10 by means of welding. Upon welding, the connection pipe section of a conventional refrigerant pipe is subject to thermal deformation due to heat generated during the welding process so that the strength of the connection coupling may be weakened. According to the present exemplary embodiment, however, the connection pipe section 30 has a relatively large thickness “t1” so that the strength of the connection pipe section 30 of the refrigerant pipe 5 is not lowered if the connection pipe section 30 is subject to the thermal deformation. Thus, the connection pipe section 30 of the refrigerant pipe 5, which is coupled with the coupling section 10, can be prevented from being broken even if vibration is applied to the refrigerant pipe 5 during the refrigeration cycle.

Since the connection pipe section 30 has a relatively large thickness “t1”, the coupling strength between the refrigerant pipe and the components 1, 2, 3 and 4 can be enhanced. In addition, since the thickness “t2” of the main pipe section 20 having a length longer than that of the connection pipe section 30 is not changed, the amount of materials used for manufacturing the refrigerant pipe 5 are not significantly increased.

According to a non-limiting embodiment of the present invention, the thickness “2” of the main pipe section 20 may be set within a range of 0.35 to 0.45 mm, taking the thickness of a typical refrigerant pipe into consideration. In addition, the thickness “t1” of the connection pipe section 30 may be set within a range of 0.45 to 0.55 mm, taking heat generated during the welding process and vibration generated during the refrigeration cycle into consideration.

When the connection pipe section 30 is welded to the coupling section 10, an end of the connection pipe section 30 may be inserted into the coupling section 10 by a length of about 5 to 15 mm. In this configuration, the welding process is performed at an end of the coupling section 10 and an outer peripheral surface of the connection pipe section 30 corresponding to the end of the coupling section 10. The welding includes applying a welding section 10a at the outer peripheral surface of the connection pipe section 30 corresponding to the end of the coupling section 10 so as to join the connection pipe section 30 and the coupling section 10 at the welding section 10a. Thus, the welding process can be performed to prevent the connection pipe section 30 and the coupling section 10 from moving relative to each other. At this time, welding heat may exert an influence upon the region of the connection pipe section 30 adjacent to the welding section 10a. Thus, the connection pipe section 30 preferably may have a length “1” within a range of about 25 to 35 mm, taking the thermal deformation in the vicinity of the welding section and the amount of materials into consideration.

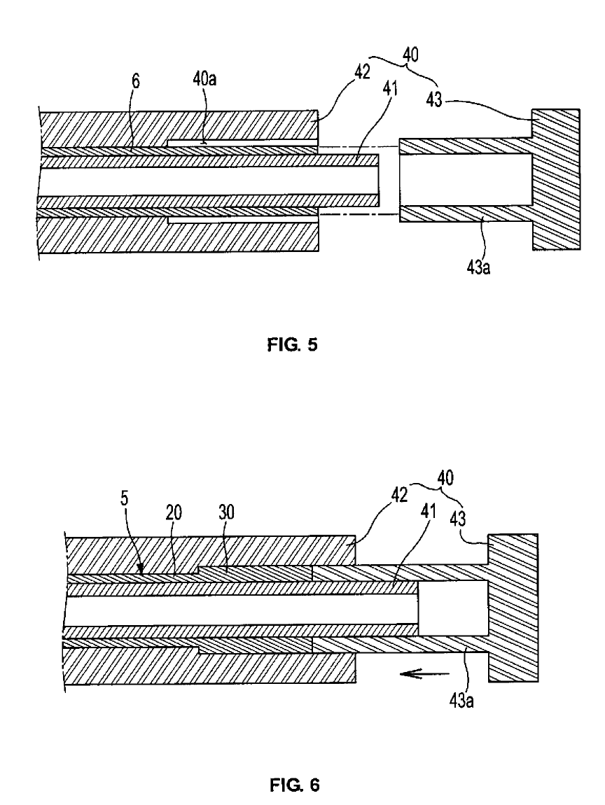

As shown in FIG. 4, the refrigerant pipe 5 may be manufactured through the steps of forming a linear primary pipe 6 having a constant thickness “t3” utilizing a drawing process used to manufacture conventional refrigerant pipe and then forming the connection pipe section 30 by deforming both ends of the linear primary pipe 6 by applying pressure lengthwise along the linear primary pipe 6 before the linear primary pipe 6 has been completely cooled. The drawing process includes using heated material to form the pipe, with the material being heated so it can be more easily deformed. The thickness “t3” of the primary pipe 6 is identical to the thickness “t2” of the main pipe section 20 of the refrigerant pipe 5, and a pressing device 40 shown in FIGS. 5 and 6 is used to deform the linear primary pipe 6.

The pressing device 40 comprises a pin member 41 that is inserted into one end of the primary pipe 6, a fixing jig 42 surrounding one end of the primary pipe 6, and a pressing member 43a having a pipe shape adapted to be inserted between the pin member 41 and the fixing jig 42. The pressing member 43a includes a pressing tool 43 for pressing one end of the primary pipe 6 to deform one end of the primary pipe 6.

A first space 40a is formed at an inner portion of the fixing jig 42. The first space 40a includes a gap formed between an outer surface of the pin member 41 and an inner surface of the fixing jig 42, the first space 40a being aligned along the same axis as the pressing member 43a. The first space 40a has a thickness corresponding to the thickness of the connection pipe section 30 of the refrigerant pipe 5. In addition, a second space, having a size smaller than the first space 40a, is formed next to the first space 40a. The second space includes a gap formed between the outer surface of the pin member 41 and the inner surface of the fixing jig 42 wherein the gap is substantially the same as the thickness “t3” of the primary pipe 6. The first space 40a has a length that is longer than the length of the connection pipe section 30.

As shown in FIG. 5, the fixing jig 42 receives the primary pipe 6 after the drawing process has been finished such that one end of the primary pipe 6 is aligned in the space 40a, and the pin member 41 is inserted into the primary pipe 6. In this configuration, as shown in FIG. 6, the pressing tool 43 is operated such that the pressing member 43a is introduced into the gap formed between the pin member 41 and the fixing jig 42 in the space 40a. Thus, one end of the primary pipe 6 is pressed by the pressing member 43a so that the length of the primary pipe 6 is shortened lengthwise along the space 40a and the thickness of the primary pipe 6 is enlarged at one end of the primary pipe 6, thereby forming the connection pipe section 30.

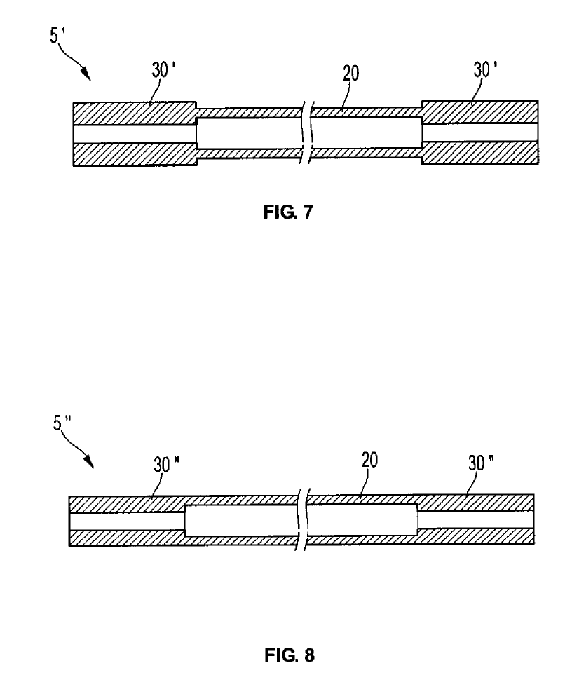

FIGS. 7 and 8 show structures of refrigerant pipes 5′ and 5″ according to another embodiment of the present invention. As illustrated in FIG. 7, a refrigerant pipe 5′ can have the thickness of a connection pipe section 30′ increased relative to the thickness of the main pipe section 20 by allowing the connection pipe section 30′ to have an inner diameter smaller than that of the main pipe section 20 as well as an outer diameter larger than that of the main pipe section 20. As illustrated in FIG. 8, a refrigerant pipe 5″ can have the thickness of a connection pipe section 30″ increased relative to the thickness of the main pipe section 20 by allowing the connection pipe section 30″ to have an inner diameter smaller than that of the main pipe section 20 while having and outer diameter identical to that of the main pipe section 20. Such refrigerant pipes 5′ and 5″ can be fabricated by modifying the shape of the space 40a, the pin member 41 and the fixing jig 42 in correspondence with the shape of the refrigerant pipes 5′ and 5″. Accordingly, the pressing device 40 may have various shapes in correspondence with the shape of the refrigerant pipes 5′ and 5″ so that pressing device 40 can form the connection pipe sections 30′ and 30″ by deforming the end of the primary pipe 6.

By increasing the thickness of the connection pipe section 30, the strength of the connection pipe section 30 is reinforced so that the coupling strength between the refrigerant pipe and the components of the refrigeration cycle can be improved. In addition, since the thickness of the main pipe section 20 is not increased and since the main pipe section 20 has a length longer than that of the connection pipe sections 30, it is not necessary to significantly increase the amount of materials used for manufacturing the refrigerant pipe.

According to a method of manufacturing the refrigerant pipe 5, the refrigerant pipe 5, including the connection pipe sections 30 having relatively large thickness, can be obtained by pressing both ends of the primary pipe 6 after the drawing process for the primary pipe 6 has cooled.

While certain exemplary embodiments of the present invention have been shown and described with reference to certain preferred embodiments thereof it will be understood by those skilled in the art that various changes in form and details may be made therein without departing from the spirit and scope of the invention as defined by the appended claims and their equivalents.

What is claimed is:

1. A refrigerant pipe for a refrigeration cycle having components including a compressor, a condenser, an evaporator and an expander that are connected to each other via the plurality of refrigerant pipes such that the refrigeration cycle forms a closed loop, each refrigerant pipe comprising:
a main pipe section having a first and a second end; and
a connection pipe section at the first end and the second end of the main pipe section configured to be connected to the components of the refrigeration cycle;
wherein a thickness of the connection pipe section is larger than a thickness of the main pipe section.

2. The refrigerant pipe as claimed in claim 1, wherein each component has a coupling section to be coupled with the connection pipe section, and the connection pipe section is welded to the coupling section in a configuration in which at least a part of the connection pipe section is inserted into the coupling section.

3. The refrigerant pipe as claimed in claim 2, wherein the connection pipe section has a length of about 25 to 35 mm.

4. The refrigerant pipe as claimed in claim 1, wherein the thickness of the connection pipe section is between about 0.45 to 0.55 mm, and the thickness of the main pipe section of the refrigerant pipe is between about of 0.35 to 0.45 mm.

5. The refrigerant pipe as claimed in claim 1, wherein the connection pipe section has an inner diameter substantially the same as an inner diameter of the main pipe section.

6. The refrigerant pipe as claimed in claim 1, wherein the connection pipe section has an inner diameter smaller than an inner diameter of the main pipe section.

7. The refrigerant pipe as claimed in claim 6, wherein the connection pipe section has an outer diameter substantially the same as an outer diameter of the main pipe section.

8. The refrigerant pipe as claimed in claim 6, wherein the connection pipe section has an outer diameter larger than an outer diameter of the main pipe section.

9. A method of manufacturing a refrigerant pipe for a refrigeration cycle having components including a compressor, a condenser, an evaporator and an expander that are connected to each other via the refrigerant pipe such that the refrigeration cycle forms a closed loop, the method comprising:
forming connection pipe sections at a first end and a second end of the refrigerant pipe such that the connection pipe sections have a thickness larger than a thickness of a main pipe section formed between the connection pipe sections;
wherein the refrigerant pipe is obtained by forming a linear primary pipe having a constant thickness through a drawing process, and then forming the connection pipe sections by deforming both ends of the linear primary pipe while applying pressure lengthwise along the linear primary pipe.

10. The method as claimed in claim 9, wherein the connection pipe section is formed by means of a pressing device including a pin member inserted into one end of the primary pipe, a fixing jig surrounding one end of the primary pipe, and a pressing tool introduced between the pin member and the fixing jig to press one end of the primary pipe, wherein:
a first space is formed at an inner portion of the fixing jig along the same axis as the pressing tool;
a first gap is formed between an outer surface of the pin member and an inner surface of the fixing jig in the first space, wherein the first gap has a thickness substantially the same as the thickness of the connection pipe section of the refrigerant pipe;
a second space having a size smaller than that of the first space is formed next to the first space; and
a second gap is formed between the outer surface of the pin member and the inner surface of the fixing jig in the second space, wherein the second gap has a thickness substantially the same as the thickness of the primary pipe.
